(19) United States
(12) Patent Application Publication
(10) Pub. No.: US 2009/0112804 A1
(43) Pub. Date: Apr. 30, 2009

(54) METHOD FOR THE CREATION OF TRANSIENT PHONEBOOK CONTACTS

(75) Inventor: Carlos Quiroz-Castro, Helsinki (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/930,325

(22) Filed: Oct. 31, 2007

(51) Int. Cl. G06F 17/30

(52) U.S. Cl. 707/3; 707/E17.001

(57) ABSTRACT

A method that includes searching a contact database for at least one contact entry; detecting a contact expiration flag associated with the at least one contact entry; comparing the contact expiration flag to a current date; and deleting the contact entry from the contact database if the expiration flag is older than the current date.

### BACKGROUND

1. Field

The disclosed embodiments generally relate to contact applications, and in particular to automatically updating and deleting contacts from a contact application.

2. Brief Description of Related Developments

Phone directories and contact information stored on a mobile telephone are generally limited by the amount of useable memory in the device and the need to continuously add and update numbers in an address book application. Users need to manually add and pull the details of the contacts and feed them to an address book or other contact application on the mobile device. Later, if the user finds that the contact details are no longer needed, the entries will need to be deleted to avoid overwhelming or exhausting the available memory resources. This requires the user to manually review the contact details and execute a delete function or command.

Contacts stored in the phonebook or address book application are permanently stored until the user explicitly deletes them. While this behaviour is appropriate in some cases, there are many situations where it would be desirable to automatically delete a phonebook or address book entry when it is not needed anymore, without requiring such a manual effort on the part of the user. Such situations can include for example, contacts that are only needed for a short time, such as for a specific meeting, contacts that are private by nature and thus should be deleted, or contacts used while travelling to a particular place. In all these situations it would be useful that the device could automatically search for, identify and delete unused contacts, based on certain criteria. Automatic removal of unneeded contacts would also reduce the phonebook clutter.

Most Nokia™ phones and devices include a component or application, often called a phonebook, which keeps a database of well-known contacts or services data relevant to the user. Typical information stored in such databases can include, but are not limited to, the contact's name(s), phone numbers, email(s), and addresses, etc. The phone book database is used as a handy replacement of memorizing data pieces such as a phone number, instead relying on well-known identification, such as the contact's name. The contact information can be stored in the device storage area, for example in a main memory or, in the case of a GSM phone, additionally/instead in a SIM card of the device. The phonebook, which can also be referred to as an address book or contact database, is an essential component on such devices to store the user's personal data and to ease dialing or messaging to other people. Similar applications can include for example, call logs, recently used contact logs and missed call logs. Each of these logs record and store information related to contacts.

It would be advantageous to be able to designate contacts in these devices with an expiration time and date, and then be able to automatically remove expired or unneeded contacts from the contact application without the need for user intervention.

### SUMMARY

In one aspect the disclosed embodiments are directed to a method that includes searching a contact database for at least one contact entry; detecting a contact expiration flag associated with the at least one contact entry; comparing the contact expiration flag to a current date; and deleting the contact entry from the contact database if the expiration flag is older than the current date.

In another aspect, the disclosed embodiments are directed to an apparatus. The apparatus can include a processor configured to assign an expiration flag to a contact entry in a contacts application, a processor configured to execute a search of all contacts on the contacts application and determine which contacts have an expired expiration flag; and a processor configured to automatically delete all expired contacts.

In a further aspect, the disclosed embodiments are directed to a system. The system can include means for searching for an expiration flag associated with a contact entry in a contacts application; means for determining which contacts have an expired expiration flag; and means for automatically deleting all expired contacts.

In yet another aspect, the disclosed embodiments are directed to a computer program product stored in a memory. The computer program product can include a computer useable medium having computer readable code means embodied therein for causing a computer to automatically delete contact data in a contacts application. The computer readable code means in the computer program product can include computer readable program code means for causing a computer to search for an expiration flag associated with a contact entry in a contacts application; computer readable program code means for causing a computer to determine which contacts have an expired expiration flag; and computer readable program code means for causing a computer to automatically delete all expired contacts.

### BRIEF DESCRIPTION OF THE DRAWINGS

The foregoing aspects and other features of the embodiments are explained in the following description, with reference to the accompanying drawings, in which:

FIG. 1 illustrates one example of a system in which aspects of the disclosed embodiments may be applied;

FIGS. 2A and 2B illustrates examples of screen shots of a contact application data entry screen in accordance with the disclosed embodiments;

FIG. 3 illustrates one example of a process of creating and/or updating contacts that have an expiration field according to the disclosed embodiments;

FIG. 4 illustrates one example of a process to change transient contacts to permanent contacts according to the aspects of the disclosed embodiments;

FIG. 5 illustrates one example of a process to monitor and check contacts for expiration flags in accordance with the aspects of the disclosed embodiments;

FIGS. 6a and 6b illustrate examples of exemplary devices that can be used to practice aspects of the disclosed embodiments;

FIG. 7 illustrates one example of an architecture that can be used to practice aspects of the disclosed embodiments.

### DETAILED DESCRIPTION OF THE EMBODIMENT(s)

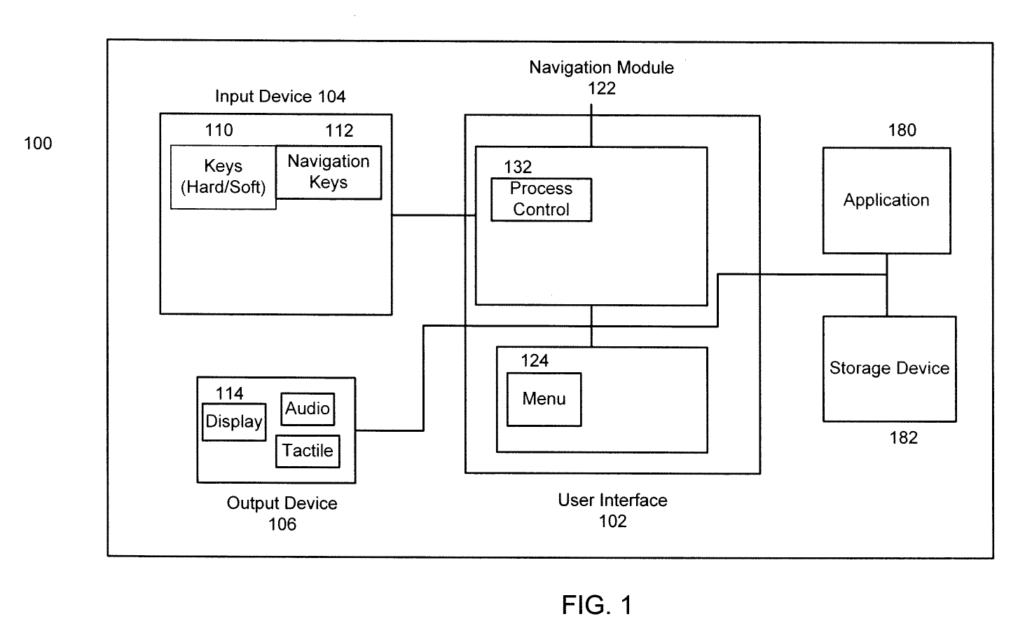

Referring to FIG. 1, one embodiment of a system 100 is illustrated that can be used to practice aspects of the claimed invention. Although aspects of the claimed invention will be described with reference to the embodiments shown in the drawings and described below, it should be understood that these aspects could be embodied in many alternate forms of embodiments. In addition, any suitable size, shape or type of elements or materials could be used.

The disclosed embodiments generally allow a user of a device or system, such as the system 100 shown in FIG. 1, to update, modify or add contact entries to a contact applications database, that include an expiration date, time or event. The system 100 is configured to automatically search and check the saved contacts and remove or delete contacts that are expired or un-needed.

In one embodiment, referring to FIG. 1, the system 100 of FIG. 1 can include an input device 104, output device 106, navigation module 122, applications area 180 and storage/memory device 182. The components described herein are merely exemplary and are not intended to encompass all components that can be included in a system 100. In one embodiment, the system 100 comprises a communication device, such as a mobile communication device or other internet application enabled device. In alternate embodiments, the system 100 can include other devices for that include contact applications and databases.

While the input device 104 and output device 106 are shown as separate devices, in one embodiment, the input device 104 and output device 106 can be part of, and form, the user interface 102. The user interface 102 can be used to display application and element information to the user, and allow the user to view, modify or update contact application entries.

In one embodiment, the user interface of the disclosed embodiments can be implemented on or in a device that includes a touch screen display. In alternate embodiments, the aspects of the user interface disclosed herein can be embodied on any suitable device that will display information and allow the selection and activation of applications.

The disclosed embodiments are directed to the creation and removal of temporal, transient or unneeded contact entries in a contact applications database. The contact entries will be referred to herein as “contact(s)”, where a “contact” refers to information stored in a contacts application or database, and can include for example, a name or other identifier, phone number(s), email address(es), physical address or other contact related information. The type of information that might comprise a “contact” is not intended to limit the scope of the disclosed embodiments.

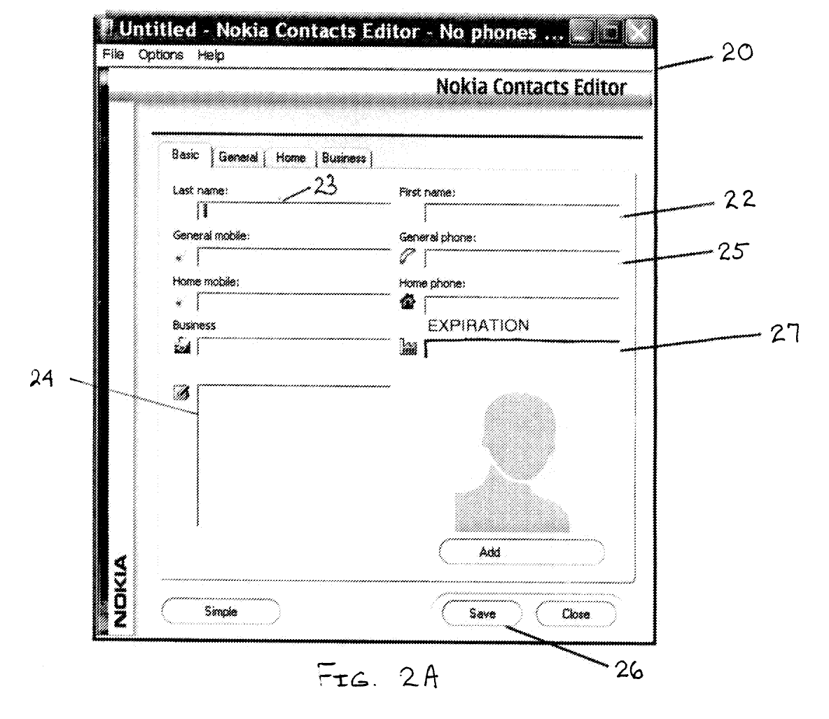

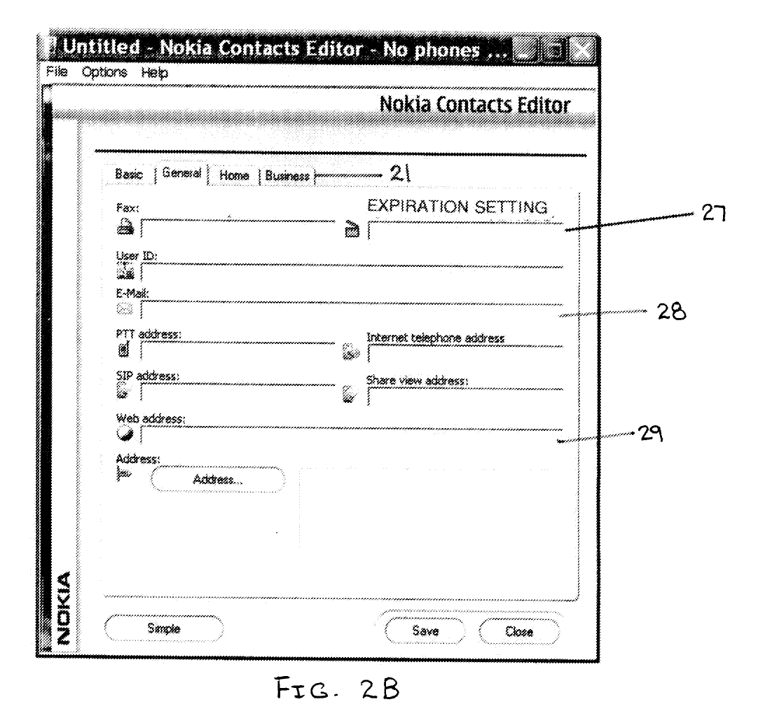

In one embodiment, a contact application comprises an address book or a phonebook. Each contact will have a specified format that can include certain fields. Generally, such formats can be application or device specific. In many situations there will be commonalities or common structure among and between the formats when entering data into a contacts application, the user will be presented with certain data fields that allow for the entry of relevant data. One example of such a contact application data entry screen 20 is shown in FIG. 2A. In this example, there are fields for a first name 22, last name 23, address 24, and telephone 25. Some of the fields may be customizable, and other fields can be displayed as well. The aspects of the disclosed embodiments provide for the creation of an additional field 27, if such a field is not already present, that will allow the user to establish an expiration date or lifespan for a contact entry. In one embodiment, as shown in FIG. 2A, the screen 20 can include an “Add Field” option 19, that allows a user to create and add a field, such as the expiration field 27. The field options can be chosen from a pre-set list, or created by the user. In alternate embodiments, any suitable process can be used to add an expiration field to a contact data screen.

Another example of a contacts editor data entry screen is shown in FIG. 2B. Additional fields might include an email address 28 and an Internet address 29. In one embodiment, the expiration field 27 could also be displayed on this screen as well. Alternatively, the expiration field 27 might only be shown on one of the screens 21. At the top of the screen, a series of tabs 21 can allow for selecting different types of data screens that allow for a variety of data to be inputted to complete contact data entry.

In one embodiment, the expiration field 27 is added to the contacts database that is resident in for example, a phonebook application of a communication device. The field 27 can be added to an existing contact or defined at the time the contact entry is created. The value of the expiration field 27 can be expressed in relative terms, such as for example, a number of hours, number of days, weeks or months. Alternatively, the value of the expiration field 27 can be expressed in absolute terms, such as a defined date and/or time. In alternate embodiments, the expiration field 27 can include any suitable time, or format, time period, date, or date interval.

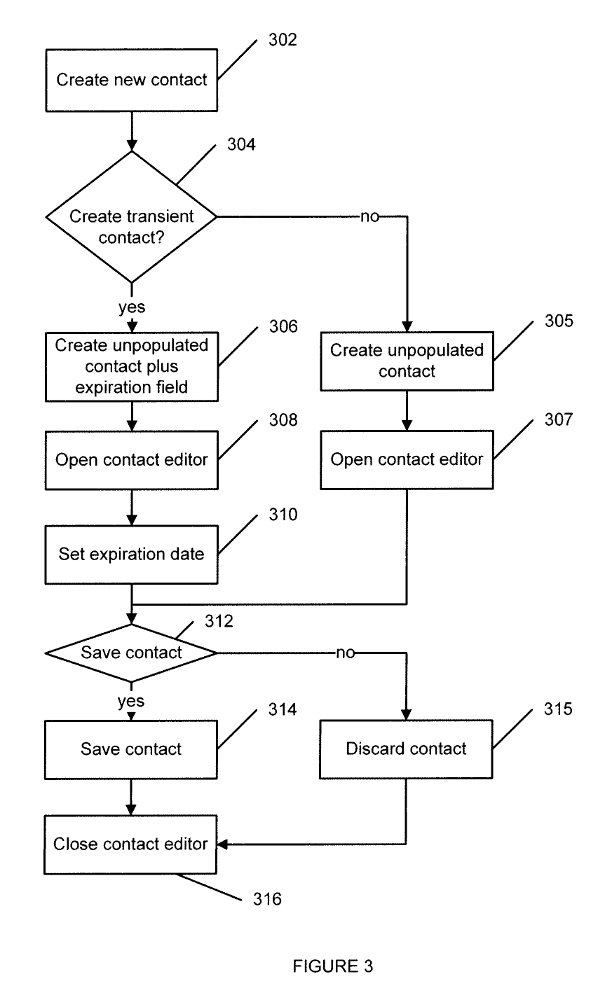

Referring to FIG. 3, one example of a process for creating a contact according to the disclosed embodiments is shown. The contact application is opened and a selection is made to create 302 a new contact. In one embodiment an option to create a transient contact 304 can be presented to the user. In alternate embodiments, the contact editor or application can automatically create each contact as a transient contact. Also, an option or selection could be presented during the creation of the contact that would allow a user to assign a permanent or indefinite expiration date for the contact.

If the user selects not to create a transient contact, the user can select 305 to create an unpopulated contact without any expiration field. Alternatively, the contact entry could include and expiration field 27 that has a permanent setting, or the user might also have the option of leaving the expiration field 27 blank. The user can then open 307 the contact editor and proceed to create the contact entry. When finished, the user can save the entry by selecting the “Save” function 26 or discard 312 the contact.

If the user chooses to create a transient contact, in one embodiment the user selects 306 to create an unpopulated contact with an expiration filed. The contact editor opens 308 to a display or menu that includes an expiration field, such as field 27 in FIG. 1. The fields of the contact data are populated, and an expiration time or date is set 310. Once all the necessary contact fields are populated the user can have the option to save 312 the contact data. The contact can be saved 314 or discarded 315, and the contact editor closed 316.

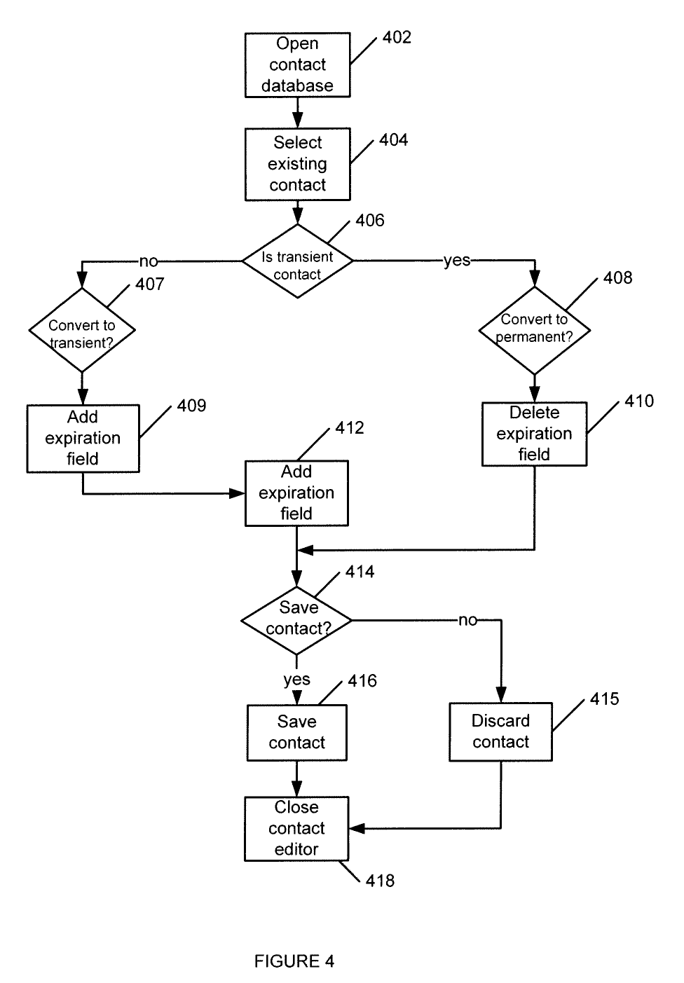

FIG. 4 illustrates one example of connecting an existing contact in a contact application into a transient contact according to the disclosed embodiments. As shown in FIG. 4, the user opens 402 the contact application or database. An existing contact is selected 404. It is determined 406 whether the selected contact is a transient contact. In one embodiment this can include examining an expiration field. In alternate embodiments, a transient contact can be highlighted in any suitable fashion to distinguish it from a non-transient contact.

In one embodiment, if the contact is transient, an option 408 can be presented to correct the contact from a transient contact to a permanent contact. In one embodiment, a transient contact can be changed to a permanent contact by deleting 410 the expiration field. In an alternate embodiment, an option can be presented and selected in the expiration field so that the end date is indefinite. The user can then have the option to save 414 the change.

If the contact is not a transient contact, the user can have the option to correct 407 the permanent contact to a transient contact. In one embodiment, an option can be presented to add 409 an expiration field to the existing contact data. This can be in the form of an options selection menu, a pull-down options menu, an add new field selection or create new field selection option. In alternate embodiments, any suitable mechanism can be used to create or add an expiration field to a data entry screen for a contacts application. Once the expiration field is added an expiration time, date or period can be added 412.

Once the expiration field data has been inputted, the user can be presented with the option 414 to save the updated contact information, including any expiration field changes or new data. If the contact changes are not saved, they can be discarded 415. If the changes are to be saved, the updated contact entry can be saved 416 and the contact editor closed.

The disclosed embodiments allow a contact application to be parsed for contacts that are expired, or were intended to be temporary, and to be automatically deleted or purged from the application. Expired or unused contacts can automatically be detected and removed. In one aspect, the system of the disclosed embodiments can go through each entry in a contact application and determine if a contact is a transient contact and an expiration date or time for the contact entry. For example, each contact entry could have one or more flags, or other indicator that identifies the entry as transient or not transient. In alternate embodiments any suitable mechanism can be used to determine if a contact entry in a contact application is transient or not transient.

In one embodiment, a check or search is made of the contacts database. If an expiration date or time is noted, it can be compared with the current time. If the expiration date is older than the current time, the contact can be considered. In one embodiment, expired contacts can be deleted from the application or database. In alternate embodiments, any suitable process can be used to remove or purge expired contacts, including for example, saving the expired contact to an archive be reviewed and selected/unselected for permanent removal or transfer.

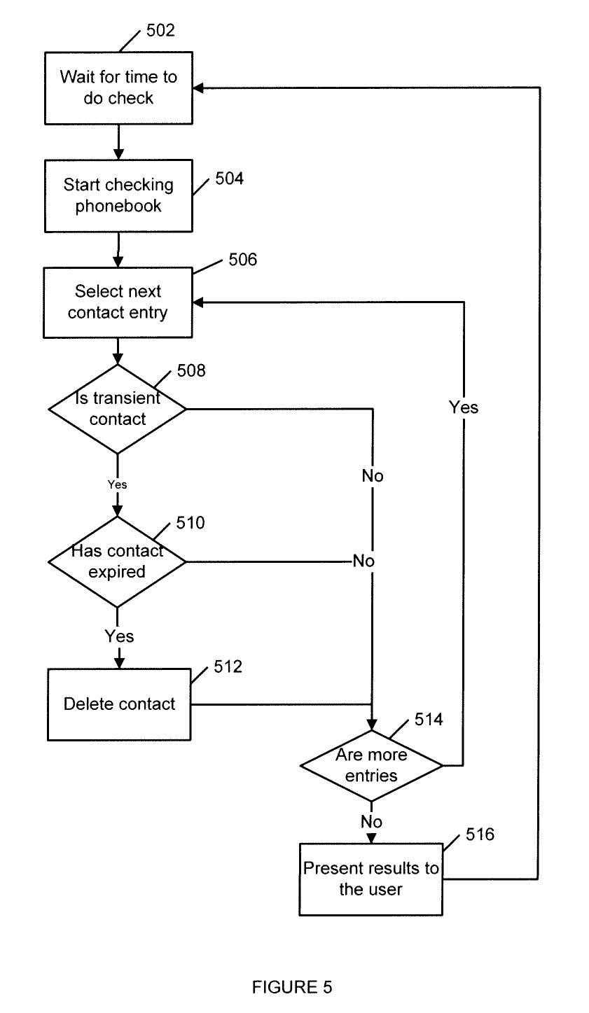

For example, referring to FIG. 5, one embodiment of a process to search and check for expired contacts is illustrated. The system of the disclosed embodiments waits 502 according to a search time schedule to initiate the search. The time interval or periodicity for the search can be any suitable time or period. For example, a user might select or set to check one or more times a day, week, month or any suitable period. The searches or checks can execute automatically without the need for user intervention, or can be user initiated or activated.

The system initiates 504 the contact data check. An entry is selected 406. The selection of the next entry to check 506 can be based on any suitable criteria, including for example, alphabetical order, date entered or date used. In alternate embodiments, any suitable criteria can be used to set an order of examination or checking.

Once a contact is selected, it is determined 508 whether the contact is a transient contact. Any suitable mechanism can be used to determine if a contact is transient, including for example, checking a transient contact flag field or checking for the presence of a transient contact date field. If the contact is not transient, it is determined 514 whether there are any more entries to be checked. If yes, the next entry is selected 506. If not, the system can wait 502 for the next check or search cycle. In one embodiment, the results may be presented 516 to the user.

If the contact is a transient contact, a determination 510 is made as to whether the contact has expired by examining the expiration flag or other flag indicator. If the contact has not expired, it is determined 514 if there are anymore contact entries. If the contact has expired, the contact can be removed 512 from the contact application database. If there are anymore entries 514, the next entry is selected 506. Otherwise, the results of the check and search are recorded or logged. In one embodiment, the results can be presented 516 to the user.

In addition to checking for transient contacts as discussed above, in one embodiment, the system can also check each contact entry for other indicators and flags to determine if the contact entry is not needed anymore and can be removed or deleted. For example, the disclosed embodiments provide for checking each contact entry, whether permanent or transient, for certain predetermined criteria. This criteria might include for example, a last accessed date/time, the last called date/time, entry date/time, blacklist or last updated date/time. This information or data can be associated with the contact in any suitable manner. In alternate embodiments, any suitable criteria can be used to determine if a contact entry is needed. The criteria can be user selected and will allow the system to determine whether or the contact entry is needed. If the predetermined criteria is met, the contact, permanent or transient, can be removed or deleted.

For example, in one embodiment, as the contact entry is checked, it is determined whether the contact has been called or contacted from the device over a certain period of time. If not, the contact can be purged or deleted, or removed to a “to be deleted” list, where the user has an option to delete or not delete the entry.

As an alternative to deleting a contact for which the “not used” criteria is met, the contact entry can be marked or flagged as “not recently used.” This can include both permanent and transient contacts. Then, either automatically at a later point or manually by the user, these flagged contact entries can be deleted, removed, purged or otherwise updated. This allows unused or unneeded contact entries to be purged from the contact application, if so desired.

Although the disclosed embodiments are described with respect to a phone book or address book application, in one embodiment, a call log could be marked with transient or permanent contacts. For example, in a mobile communication device, such as a mobile phone, call logs are kept. These logs can include recent call logs and missed call logs. These entries can be stored in the phone until deleted. In one embodiment, the entries in a call log can be tagged with a transient identifier. After a pre-determined period, the call data can be deleted unless the user elects to make the call data a permanent entry. This provides the advantage of automatically clearing out call logs from unwanted numbers and other contact information.

The aspects of the disclosed embodiments can be implemented on any device that includes a user interface for the display and accessing of information, such as the system 100 shown in FIG. 1. In one embodiment, the input device 104 can generally comprise a keypad or other suitable input mechanism. For example, in one embodiment, the input device 104 can include a touch screen display 112. The inputs and commands from a user, such as the touching of the screen, are received in the input module 104 and passed to the navigation module 122 for processing. The navigation module 122 can determine and set the state of the device. The output device 106, can receive data from the user interface 102, application 180 and storage device 182, for output to the user in a suitable format.

Each of the input device 104 and output device 106 are configured to receive data or signals in any format, configure the data or signals to a format compatible with the application or device 100, and then output the configured data or signals. While a display 114 is shown as part of the output device 106, in other embodiments, the output device 106 could also include other components and device that transmit or present information to a user, including for example audio devices and tactile devices.

The user input device 104 can include controls that allow the user to interact with and input information and commands to the device 100. The output device 106 can be configured to provide the content of the exemplary screen shots shown herein, which are presented to the user via the functionality of the display 114. Where a touch screen device is used, the displays 112 and 114 can comprise the same or parts of the same display. User inputs to the touch screen display are processed by, for example, the touch screen input control 112 of the input device 104. The input device 104 can also be configured to process new content and communications to the system 100. The navigation module 122 can provide controls and menu selections, and process commands and requests. Application and content objects selection and activation can be provided by the menu control system 124. The process control system 132 can receive and interpret commands and other inputs, interface with the application module 180, storage device 180 and serve content as required. Thus, the user interface 102 of the embodiments described herein, can include aspects of the input device 104 and output device 106.

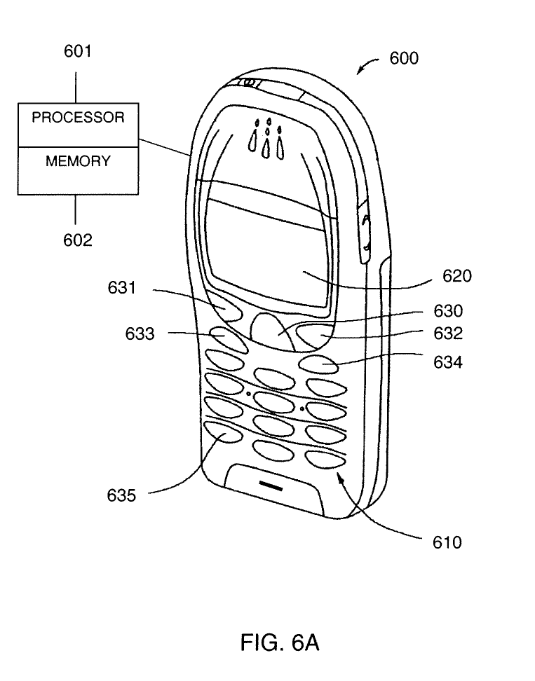

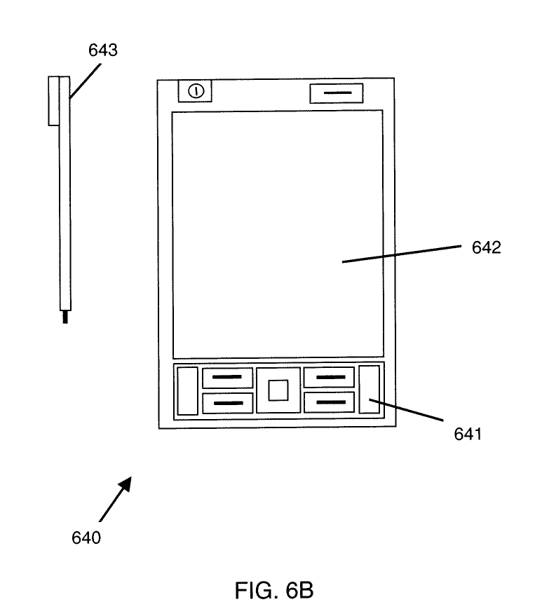

Examples of devices on which aspects of the disclosed embodiments can be practiced are illustrated with respect to FIGS. 6A and 6B. In alternate embodiments, the devices can include device that has or uses a contact application. The terminal or mobile communications device 600 may have a keypad 610 and a display 620. The keypad 610 may include any suitable user input devices such as, for example, a multi-function/scroll key 630, soft keys 631, 632, a call key 633, an end call key 634 and alphanumeric keys 635. The display 620 may be any suitable display, such as for example, a touch screen display or graphical user interface. The display may be integral to the device 600 or the display may be a peripheral display connected to the device 600. A pointing device, such as for example, a stylus, pen or simply the user's finger may be used with the display 620. In alternate embodiments any suitable pointing device may be used. In other alternate embodiments, the display may be a conventional display. The device 600 may also include other suitable features such as, for example, a camera, loud speaker, connectivity port or tactile feedback features. The mobile communications device may have a processor 601 connected to the display for processing user inputs and displaying information on the display 620. A memory 602 may be connected to the processor 601 for storing any suitable information and/or applications associated with the mobile communications device 600 such as phone book entries, calendar entries, etc.

In one embodiment, the system 100 of FIG. 1 may be for example, a PDA style device 640 illustrated in FIG. 6B. The PDA 640 may include one or more of the following features, a keypad 641, a touch screen display 642 and a pointing device 643 for use on the touch screen display 642. In still other alternate embodiments, the device may be a personal communicator, a tablet computer, a laptop or desktop computer, a television or television set top box, or any other suitable device capable of containing the display 642 and supported electronics such as a processor and memory, and capable of including a contact application and/or database. The exemplary embodiments herein will be described with reference to the mobile communications device 600 for exemplary purposes only and it should be understood that the embodiments could be applied equally to any suitable device incorporating a display, processor, memory and supporting software or hardware, that can be used with or include a contacts application, address book or phone book.

The user interface 102 of FIG. 1 can also include a menu system 124 in the navigation module 122. The navigation module 122 provides for the control of certain states, processes and utilities of the device 100. The menu system 124 can provide for the selection of different tools and application options related to the applications or programs running on the device 100. In the embodiments disclosed herein, the navigation module 122 receives certain inputs, such as for example, signals, transmissions, instructions or commands related to the functions of the device 100. Depending on the inputs, the navigation module interprets the commands and directs the process control 132 to execute the commands accordingly. In one embodiment, the menu system 124 can allow of the selection of a contact entry and the addition of, or updating of an expiration field or other lifespan flag as described herein. The process control 132 can interpret the expiration field(s) or other lifespan flags and indicators. The navigation module 122 can also control the automatic parsing and checking of the contact entries in the contact application for expiration flags and other use indicators, as described herein. The navigation module 122 and process control 132 can interpret the flags and control the removal, deletion or updating of contact entries in accordance with the aspects of the disclosed embodiments.

Activating a control generally includes any suitable manner of selecting or activating a function associated with the device, including touching, pressing or moving the input device. In one embodiment, where the input device 104 comprises control 110, which in one embodiment can comprise a device having a keypad, pressing a key can activate a function. Alternatively, where the control 110 of input device 104 also includes a multifunction rocker style switch, the switch can be used to select a menu item and/or select or activate a function. When the input device 104 includes control 112, which in one embodiment can comprise a touch screen pad, user contact with the touch screen will provide the necessary input. Voice commands and other touch sensitive input devices can also be used.

Although the above embodiments are described as being implemented on and with a mobile communication device, it will be understood that the disclosed embodiments can be practiced on any suitable device that can include or interface with a contact application, phone book or address book. For example, the device 100 of FIG. 1 can generally comprise any suitable electronic device, such as for example a personal computer, a personal digital assistant (PDA), a mobile terminal, a mobile communication terminal in the form of a cellular/mobile phone, or a multimedia device or computer. In alternate embodiments, the device 100 of FIG. 1 may be a personal communicator, a mobile phone, a tablet computer, a laptop or desktop computer, a television or television set top box a DVD or High Definition player or any other suitable device capable of containing for example a display 114 shown in FIG. 1, and supported electronics such as the processor 601 and memory 602 of FIG. 6A. For description purposes, the embodiments described herein will be with reference to a mobile communications device for exemplary purposes only and it should be understood that the embodiments could be applied equally to any suitable device incorporating a display, processor, memory and supporting software or hardware. The device 100 may also include other suitable features such as, for example, a camera, loudspeaker, connectivity port or tactile feedback features.

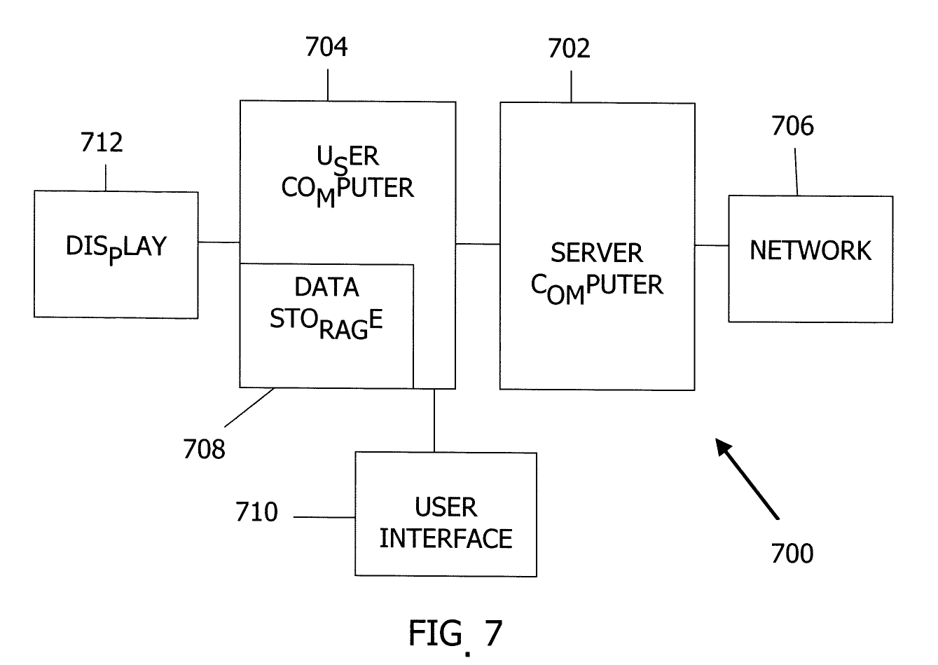

The disclosed embodiments may also include software and computer programs incorporating the process steps and instructions described above that are executed in different computers. FIG. 7 is a block diagram of one embodiment of a typical apparatus 700 incorporating features that may be used to practice aspects of the invention. The apparatus 700 can include computer readable program code means for carrying out and executing the process steps described herein. As shown, a computer system 702 may be linked to another computer system 704, such that the computers 702 and 704 are capable of sending information to each other and receiving information from each other. In one embodiment, computer system 702 could include a server computer adapted to communicate with a network 706. Computer systems 702 and 704 can be linked together in any conventional manner including, for example, a modem, wireless, hard wire connection, or fiber optic link. Generally, information can be made available to both computer systems 702 and 704 using a communication protocol typically sent over a communication channel or through a dial-up connection on ISDN line. Computers 702 and 704 are generally adapted to utilize program storage devices embodying machine-readable program source code, which is adapted to cause the computers 702 and 704 to perform the method steps, disclosed herein. The program storage devices incorporating aspects of the invention may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 702 and 704 may also include a microprocessor for executing stored programs. Computer 702 may include a data storage device 508 on its program storage device for the storage of information and data. The computer program or software incorporating the processes and method steps incorporating aspects of the invention may be stored in one or more computers 502 and 504 on an otherwise conventional program storage device. In one embodiment, computers 502 and 704 may include a user interface 510, and a display interface 512 from which aspects of the invention can be accessed. The user interface 510 and the display interface 512 can be adapted to allow the input of queries and commands to the system, as well as present the results of the commands and queries.

The disclosed embodiments provide for highlighting or making contact entries in a contact application as permanent or transient. If transient, specific expiration periods or dates can be set. During a check of the contacts database, expired contacts can be deleted or otherwise updated or removed form the database. Permanent contacts can be corrected to transient contacts while transients can be made permanent. Periodic checks of the contacts applications can be made.

Additionally, all contact entries can be checked for the other criteria that might indicate the contact is not needed or rarely used. Such contacts can also be deleted or purged from the contact application database, or updated to extend the life of the contact entry. This provides the advantage of automatically removing unwanted or unneeded contacts in a contact application.

It should be understood that the foregoing description is only illustrative of the embodiments. Various alternatives and modifications can be devised by those skilled in the art without departing from the embodiments. Accordingly, the disclosed embodiments are intended to embrace all such alternatives, modifications and variances that fall within the scope of the appended claims.

1. A method comprising:
searching a contact database for at least one contact entry;
detecting an expiration flag associated with the at least one contact entry;
comparing the expiration flag to a current date; and
removing the contact entry from the contact database if the expiration flag is older than the current date.

2. The method of claim 1 further comprising if an expiration flag is not associated with the at least one contact entry, assigning an expiration flag to the at least one contact entry.

3. The method of claim 2 wherein assigning an expiration field further comprises creating an expiration field and adding the expiration field to the contact entry in the contacts database.

4. The method of claim 3 wherein the expiration date is a relative date or an absolute date.

5. The method of claim 1 further comprising, if an expiration flag is not associated with the at least one contact entry:
determining if the at least one contact entry has been accessed within a pre-determined period of time; and
if not, deleting the at least one contact entity.

6. The method of claim 5, wherein deleting the at least one contact entity further comprises storing the deleted contact entity in an archive.

7. The method of claim 1 further comprising, prior to deleting the contact entry, soliciting a user input confirming deletion of the contact entry.

8. The method of claim 7 wherein the input further comprises a request to extend an expiration date of the expiration flag.

9. The method of claim 1 further comprising the searching occurring at pre-determined time intervals.

10. The method of claim 1 further comprising, if the contact entry is not purged, detecting another contact validity criteria associated with the contact entry and determining whether to purge the contact entry based on the another contact validity criteria.

11. An apparatus comprising:
a processor configured to assign an expiration flag to a contact entry in a contacts application;
a processor configured to execute a search of all contacts on the contacts application and determine which contacts have an expired expiration flag; and
a processor configured to automatically delete all expired contacts.

12. The apparatus of claim 11 further comprising the processor being configured to assign an expiration flag to a contact entry that does not have an expiration flag.

13. The method of claim 11 further comprising the processor being configured to:
determine if the at least one contact entry has been accessed within a pre-determined period of time; and
if not, delete the at least one contact entity.

14. A system comprising:
means for searching for an expiration flag associated with a contact entry in a contacts application;
means for determining which contacts have an expired expiration flag; and
means for automatically deleting all expired contacts.

15. The system of claim 14 further comprising means for determining, if an expiration flag is not associated with a contact entry, if the contact entry has been accessed within a pre-determined period of time; and if not, deleting the contact entity.

16. The system of claim 14 further comprising means for detecting a second contact validity criteria associated with the contact entry prior to deleting an expired contact entry and determining whether to purge the contact entry on the basis of the combination of the expiration flag and the second contact validity criteria.

17. A computer program product stored in a memory comprising:
a computer useable medium having computer readable code means embodied therein for causing a computer to automatically delete contact data in a contacts application, the computer readable code means in the computer program product comprising:
computer readable program code means for causing a computer to search for an expiration flag associated with a contact entry in a contacts application;
computer readable program code means for causing a computer to determine which contacts have an expired expiration flag;
computer readable program code means for causing a computer to automatically delete all expired contacts.

18. The computer program product of claim 17 further comprising computer readable program code means for causing a computer to determine, if an expiration flag is not associated with a contact entry, if the contact entry has been accessed within a pre-determined period of time; and if not, deleting the at least one contact entity.

19. The computer program product of claim 17 further comprising computer readable program code means for causing a computer to update an expired contact entry to extend the a lifespan of the contact entry upon determining that the contact entry is expired and a user input requests an extension.

20. The computer program product of claim 17 further comprising computer readable program code means for causing a computer to detect a second contact validity criteria associated with the contact entry prior to deleting an expired contact entry and determining whether to purge the contact entry on the basis of the combination of the expiration flag and the second contact validity criteria.
